(19) United States
(12) Patent Application Publication
(10) Pub. No.: US 2026/0153394 A1
(43) Pub. Date: Jun. 4, 2026

(54) IMPACT INDICATOR

(71) Applicant: HIGS AB, ÅRE (SE)

(72) Inventor: Niclas Gravenfors, ÅRE (SE)

(21) Appl. No.: 19/457,257

(22) Filed: Jan. 23, 2026

Related U.S. Application Data
(63) Continuation of application No. PCT/SE2024/050640, filed on Jun. 26, 2024.

(30) Foreign Application Priority Data
Jul. 26, 2023 (SE) 2350928-4

(51) Int. Cl. G01L 5/00; A42B 3/04

(52) U.S. Cl. CPC G01L 5/0052; A42B 3/046

(57) ABSTRACT

An impact indicator comprising a bottom, a transparent top and an indicating body, a centrally positioned attachment point for the indicating body, a space between the bottom and the top for the indicating body to move in, a holding means for the indicating body is provided, the attachment point is arranged to releasably hold the indicating body by a magnetic attachment force, wherein the indicating body is to be released when the impact indicator is exposed to a force that is greater than the attachment force, and the holding means along the outer edge is configured to releasably hold the released indicating body by a magnetic holding force, further the bottom is connectable to a resetting plate, the holding means is attached to the resetting plate, thus making the impact indicator resettable after an impact without opening the space between top and bottom. A helmet comprising an impact indicator.

### BACKGROUND

The various embodiments of the invention describe herein concern an impact indicator and a helmet comprising such an impact indicator.

Mild to moderate concussions, especially when repeated in the near future, can be very harmful to a person's brain. Especially, for children and young people. Mild concussions are often missed or undiagnosed. If diagnosed, the concussions can be treated successfully, but unfortunately many remain untreated due to lack of diagnosis. In light of the above, it is therefore important to alert and register your impacts to a helmet and head as well as its direction of impact. Severe concussions and impacts to the head are in most cases evident for the person, who will seek care.

It is previously known that helmets have an expiry date due to ageing material or due to an impact against the helmet. It is important that the helmet is not used after age expiry or after a large enough impact since it will not protect the head in a sufficient manner. There are previously known indicators that show if a helmet has been exposed to an impact over a threshold that indicates that the helmet should be disposed of.

Additionally, there can be problems even when the concussions are diagnosed since there are weaknesses in adherence to guiding systems.

### SUMMARY

Various embodiments of the present invention is to alleviate these and other problems, especially finding mild concussions and their occurrences in time and make sure people are discarding old helmets and helmets exposed to repeated impacts.

According to a first aspect, an impact indicator comprising a bottom, a transparent or translucent top and an indicating body is provided. The top has a centrally positioned attachment point for the indicating body. A space is present between the bottom and the top for the indicating body to move in. The space is delimited by an outer rim, along an outer edge of the impact indicator, being a portion of the bottom, the top and/or a separate part. Along the outer edge a holding means for the indicating body is provided. The attachment point is arranged to releasably hold the indicating body by means of a magnetic attachment force, wherein the indicating body and the attachment point are configured to allow the indicating body to be released when the impact indicator is exposed to a force that is greater than the magnetic attachment force. The holding means along the outer edge is configured to releasably hold the released indicating body by means of a magnetic holding force, further the impact indicator comprises a resetting plate arranged in connection with the bottom, wherein the holding means is attached at the resetting plate, thus making the impact indicator resettable after an impact without having to open the space between the top and the bottom.

As a result, it is possible to notice an impact and its impact direction. It makes it possible to keep count of impacts, due to the resetting function, and to indicate when it is time to discard the object provided with the impact indicator, for example a helmet. Further, since the impact indicator can be reset without separating the top and the bottom, the space in between may have a vacuum and/or the space will be protected against dust, water and moisture. Obviously, this will provide accurate function every time also after a reset since the conditions will stay the same inside, in the space, between the top and the bottom. Preferably, the connection between the top and bottom is at least dust, water and moisture proof.

According to a second aspect, a helmet is provided and equipped with an impact indicator as described herein.

### BRIEF DESCRIPTION OF THE DRAWINGS

Various embodiments will now be described in more detail, with reference to the attached drawings, in which

FIGS. 1a and 1b show an embodiment of an impact indicator from above and from a side, respectively.

FIG. 2 shows an embodiment of an impact indicator in a resetting position.

FIG. 3 shows an embodiment of an impact indicator in an exploded view.

FIG. 4 shows an embodiment of an impact indicator in a resetting position.

FIG. 5 shows an embodiment of an impact indicator in an exploded view.

FIG. 6 shows a side view of a top and a broken away view of a resetting plate of the embodiment of FIG. 5.

### DETAILED DESCRIPTION

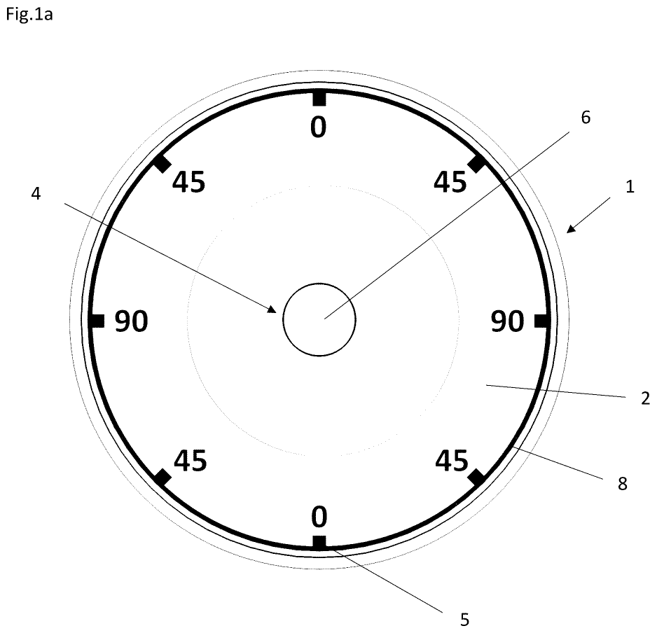

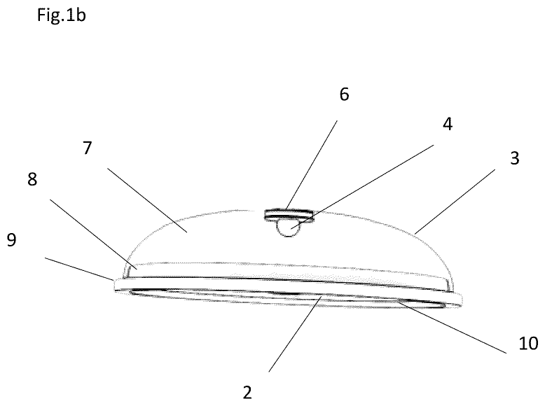

The outside shape of the impact indicator 1 may differ in shape. In FIGS. 1a and 1b it is shown having a circular shape but may have any polygon shape. The impact indicator 1 has a bottom 2, a transparent or translucent top 3 and an indicating body 4, see FIG. 1b. The bottom 2 may have angle direction markings 5 on a side facing the top 3 and the top 3 has a centrally positioned attachment point 6 for the indicating body 4. The indicating body may have any shape, but in the present embodiment it is shaped as a sphere. It may be colored with a distinctive color to be easily visible, at least a contrasting color to the bottom 2. A space 7 is present between the bottom 2 and the top 3 for the indicating body 4 to move in. The space 7 is delimited radially by an outer rim 8, along an outer edge 9 of the impact indicator 1, being a portion of the bottom 2, the top 3 and/or a separate part (not shown). In FIG. 1b the rim is made up by a portion of the top 3. Along the outer edge 9 a holding means 10 for the indicating body 4 is provided.

The attachment point 6 is arranged to releasably hold the indicating body 4 by means of a magnetic attachment force. The indicating body 4 and the attachment point 6 are configured to allow the indicating body 4 to be released when the impact indicator 1 is exposed to a force that is greater than the attachment force, a so-called threshold force for the release. The impact force could be a straight or a rotational force. The holding means 10 along the outer edge 9 is configured to releasably hold the released indicating body 4 by means of a magnetic holding force.

Thus, when the impact indicator 1 is exposed to an impact having an impact force, straight or rotational, higher than the attachment force between the attachment point 6 and the indicating body 4, the indicating body 4 is released and will travel through the space 7 towards the rim 8 and outer edge 9 of the impact indicator 1 in a travelling direction opposite the impact direction. When the indicating body 4 reaches the outer edge 9, the holding means 10 will catch and hold the indicating body 4 at the rim of the impact indicator 1 by means of the holding force. If there are direction markings 5 on the bottom 2 the impact direction can easily be detected. Since the holding means 10 holds the indicating body in a releasable manner, it makes the impact indicator 1 resettable after an impact, and the impact indicator may be used repeatedly.

Since the indicating body 4 may move from the attachment point 6 through the space 7 to the holding means 10 without any friction, at least if there is a vacuum in the space or insignificant if the space is filled with air, in exact the direction caused by an impact and the indicating body 4 will be directly caught and held by the holding means 10, without any direction controlling means, i.e., no specific pockets, holes or other means forcing/controlling the indicating body 4 to move into and thus affect the direction indication, for example sideways so that the angle will not show exact direction of the impact. Depending on how far down into the space 7 the attachment point 6 is protruding and the shape of the indicating body 4, it could be possible to provide the inside of the top 3 with a low friction layer, at least in the vicinity of the attachment point 6, in case the inside of the top 3 is rather close to the indicating body 4.

According to an embodiment the attachment force between the attachment point 6 and the indicating body 4 has a threshold attachment force where the indicating body 4 will release from the attachment point 6 when an impact occur. The threshold attachment force may be between about 10-100 G. If the impact indicator is used at a protective garment, such as a helmet, different threshold attachment forces will be set depending on the type of helmet and whether the helmet is intended for a child, youth or an adult. Having such a low threshold attachment force will give an indication of an impact that is not sufficiently large by itself to cause an injury and will not cause a need to dispatch a protective garment where the impact indicator is arranged, such as a helmet. However, it will indicate that the user needs to, for example, rest or be attentive not to cause more impacts in a certain period of time.

The holding force between the holding means 10 and the indicating body 4 after an impact is preferably the same or larger than the threshold attachment force. This will ensure that the indicating body 4 will stay at the holding means 10 even if the impact indicator is exposed to further impacts after the initial impact. This could for example happen if the user is tumbling downhill.

According to a special embodiment the top 3 will break at an impact force larger than about 200 G-300 G, depending on what type of protective garment (for example, a helmet) the top 3 is used on, and whether the protective garment is for a child, youth or an adult. Thus, it will be evident whether the protective garment, such as a helmet, needs to be disposed of. The top 3 also indicates that the user has been exposed to an impact so large that an immediate injury might have occurred. The top 3 may be more or less flat with dome shaped edges, or flat with a vertical rim or having an aerodynamical shape or any other shape not impeding the function. It is also possible to let the impact indicator release from the protective garment to which the impact indicator is attached, if the impact force is so large that the protective garment, such as a helmet, should be discarded.

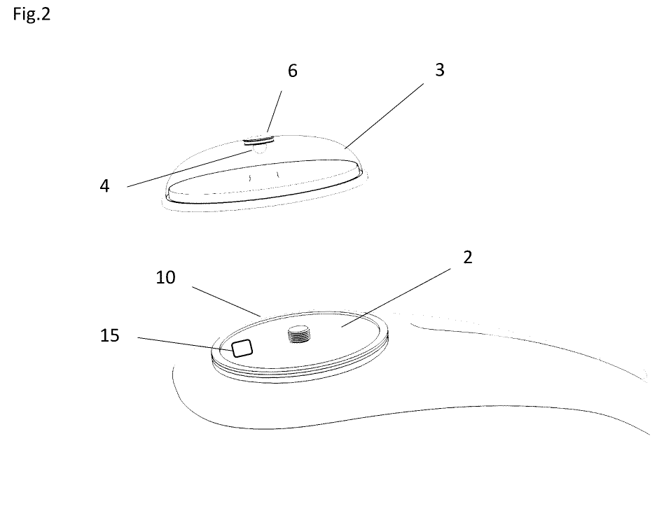

The impact indicator is resettable, and this could be provided in many ways. A few embodiments will be described here. In its simplest embodiment, the top 3 is releasably arranged at the bottom 2, for example by means of threads, bayonet coupling, snap fits or the like. The releasable attachment may be provided along the outer edge 8. Thus, after an impact the top 3 may be released and the indicator body 4 may be moved from the holding means 10 and put back on the inside of the top 3 at the centrally provided attachment point 6. Thereafter, the top 3 is reattached. In this embodiment the holding means 10 may be situated either at the rim of the top 3 or at the rim at the bottom 2. See FIG. 2.

It is possible to keep track of the number of impacts, for example, by having a mechanical counter dial or rack, preferably having a ratchet stopping any movement in the wrong direction, which would decrease rather than increase the number of impacts. In its simplest embodiment, this would be a manually operated counter. By keeping track of the number of impacts over the threshold force indicates the risk and possible need of rest or seeking medical advice. The impact indicator can also indicate when a certain number of impacts over the threshold force has been reached and the protective garment, such as a helmet, should be disposed of. In FIG. 2 an opening 15 is shown in the bottom 2. The bottom may be turned in a rotationable ratchet so that a number in sequence is shown through the opening 15. Every time a reset is done, the user may turn the bottom 2 so that next consecutive number will be shown in the opening 15.

Preferably, the resetting of the impact indicator 1 is provided by increasing a distance between the holding means 10 and the indicating body 4 so that the magnetic force between them becomes sufficiently weak that the indicating body 4 can move again. The indicating body 4 will be attracted to the attachment point 6, either automatically or with a little help, for example, by shaking or turning the impact indicator upside down (or the protective garment the impact indicator is arranged on).

This can be accomplished by having a resetting plate 12, which is arrangeable at the bottom of the impact indicator 1. The resetting plate 12 can be connectable to the bottom 2 or the edge 9 or the rim 8 in any suitable way. The holding means 10 is arranged at the resetting plate 12, for example under, above or within the resetting plate 12. When the combined top 3 and bottom 2 is moved away from the resetting plate 12 the magnetic force between the indicating body 4, being present within the space 7 between the top 3 and the bottom 2, and the holding means 10 will weaken or disappear. Then the indicating body 4 is free to reattach to the attachment point 6. The combined bottom 2 and top 3 may be totally releasable from the resetting plate 12 or movable so that a distance is provided between the resetting plate 12 and the bottom 2, which is large enough to weaken the magnetic force between the holding means at the resetting plate 12 and the indicating body 4 in the space between the bottom 2 and the top 3. This distance can be provided in many ways, wherein two ways will be shown as examples below.

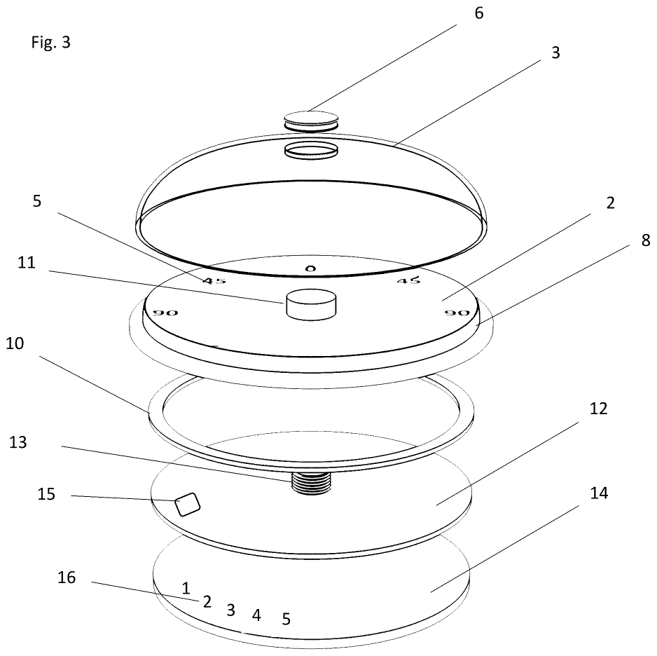

FIG. 3 shows a more elaborate embodiment of the impact indicator 1 in an exploded view. A transparent or translucent top 3 having an attachment point 6 is attached to a bottom 2. The bottom 2 has, in this embodiment, a small rim 8 cooperating with the top 3 to provide a closed space 7, wherein an indicating body 4 may move. Obviously, the connection between the top 3 and the bottom 2 may be provided in many other ways where an outer rim 8, along an outer edge 9 of the impact indicator 1, being a portion of the bottom 2, the top 3 and/or a separate part (not shown). The bottom 2 has angle indications 5 on a side facing the top 3. The attachment between the top 3 and the bottom 2 may be threaded, bayonet, snap fit or a non-separable attachment as adhesive, weld, screws or studs, for example.

This embodiment has a central attachment point 11 in the bottom 2. On an underside or inside of the center attachment point 11 threads or other attachment means are present for connection with a resetting plate 12 having a central upwards protruding attachment point 13 provided for connection with the bottom 2. Along the outer edge 9 of the resetting plate 12 is a holding means 10 being attached, facing the bottom 2 in an assembled mode of the impact indicator 1. In this embodiment, where the holding means 10 is provided underneath the bottom 2, a magnetic force is provided between the holding means 10 and the indicating body 4, also between the indicating body 4 and the attachment point 6 in the top 3. If desired, a mounting plate 14 may be provided underneath the resetting plate 12. In FIG. 3 it is present. The mounting plate 14, or the resetting plate 13 in the absence of a mounting plate 14, may be designed to match the form or the protective garment, such as a helmet, to which the mounting plate 14 should be attached.

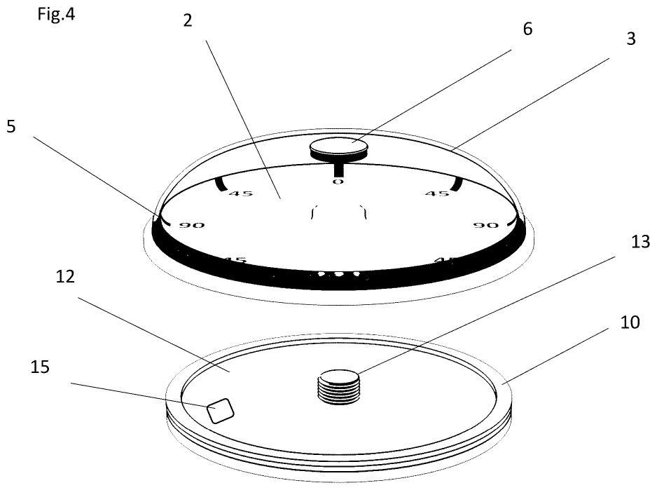

In the shown embodiment, the indicating body 4 cannot be reached by a person's fingers as it is locked into the space 7, since it is preferred not to have to open up between the top 3 and the bottom 2. Instead, as shown in FIG. 4, the combined top 3 and bottom, forming a capsule, can be raised above the resetting plate 12 so that a distance will occur between the holding means 10, arranged on the resetting plate 12, and the indicating body 4 locked in the space 7 of the combined top 3 and bottom 2. Due to the increased distance therebetween, the magnetic force between the holding means 10 and the indicating body will decrease to such an extent so the indicating body 4 instead will be influenced by the magnetic force between the attachment point 6 and the indicating body 4 and thus return to the attachment point 6.

The raising of the resetting plate 12 may for example be provided in the central attachment point 11 and the protruding attachment point 13. According to one embodiment the protruding attachment point 13 may be provided with a radial pin (not shown) which run in a slot (not shown) in the central attachment point 11, or vice versa. The slot encircles almost the full circle of the inside of the central attachment point 11 with a steep rise of the slot. Thus, when a person rotates the combined top 3 and bottom 2, the combined top 3 and bottom 2 will move upwards while the pin follows along the slot. At the top, the indicating body 4 will be so far away from the holding means 10 provided in the resetting plate 12 so that it can be drawn back to the attachment point 6, maybe with a little help of a tilt of the impact indicator. Preferably, the slot ends with a more or less vertical slot so that the combined top 3 and bottom 2 will fall back to its normal position ready for use when a full circle has been performed.

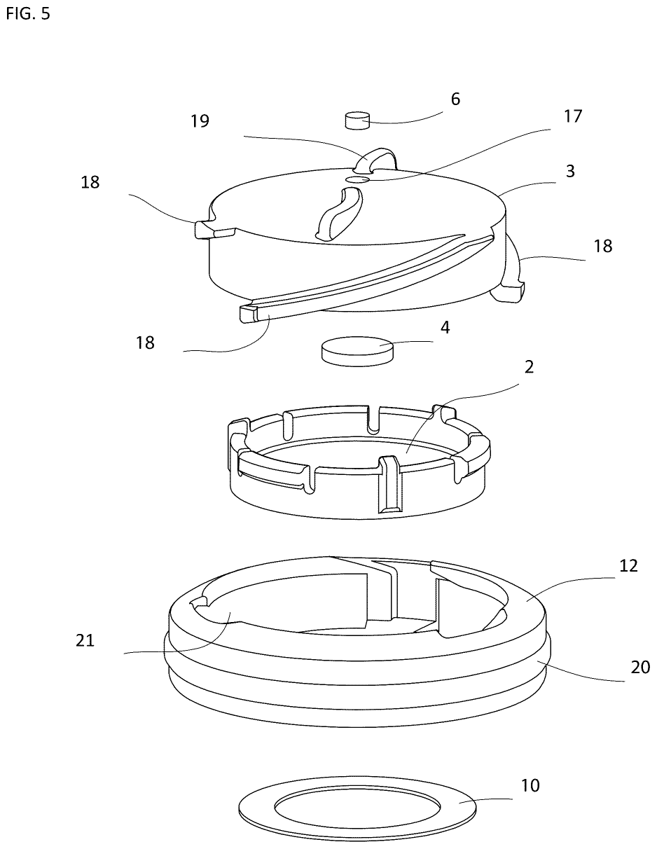

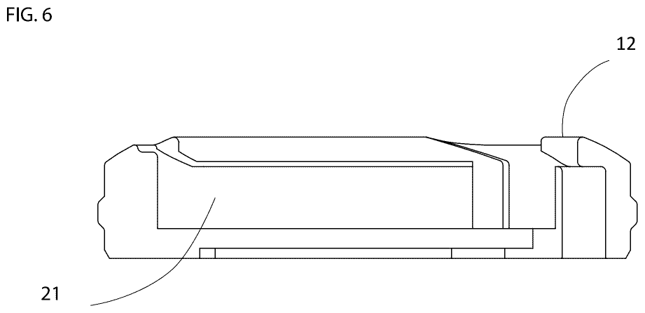

In FIG. 5 another embodiment of the impact indicator is shown in an exploded view. An attachment point 6 is positioned in a recess 17 in a top 3. The top 3 is provided with one or more slide protrusions 18, in the shown embodiment three. Preferably, one or more wings 19 are provided on the top 3 to enhance the possibility to rotate the top 3. The top 3 is attachable to a bottom 2 and the attachment is preferably dust and moisture/waterproof. The attachment between the top 3 and the bottom 2 may be threaded, bayonet, or a non-separable attachment as snap fit, adhesive, weld, screws or studs, for example. In the shown embodiment the indicating body 4 cannot be reached by a person's fingers as it is locked into the space 7, since it is preferred not to have to open up between the top 3 and the bottom 2. The bottom 2 may be provided with angle direction markings (not shown).

A resetting plate 12 is provided with a holding means 10. In the shown embodiment the resetting plate has an outer wall 20. The outer wall has at least one recess 21 for receiving the at least one slide protrusion 18. Preferably the number of slide protrusions 18 and recesses 21 corresponds. The combined top 3 and bottom 2 is positioned inside the resetting plate 12. The at least one slide protrusion 18 runs in the corresponding recess 21 when the combined top 3 and bottom 2 is rotated, whereby the slide protrusion 18 follow a gradient of the recess 21 so that the combined top 3 and bottom 2 will rise above the resetting plate 12. Thus, the distance between the holding means at the resetting plate 12 and the indicating body 4 will increase and thus the magnetic force between them will decrease. Obviously, the slide protrusion 18 may be a short pin instead running in a slot like recess 21. Or vice versa, a slide protrusion 18 (pin or longer slide protrusions as shown) may run in a slot like recess 21 provided in the top 3 or bottom 2.

Preferably, the bottom 2 has an opening 15, which is aligned with a row of successive numbers 16 so that a number on the resetting plate 12 may be seen through the opening 15 and through the top 3. For every turn of the combined top 3 and bottom 3, one greater number will be shown through the opening 15. In this way it is possible to keep a count of the number of impacts releasing the indicating body 4. This could be done manually as previously described. In this more advanced embodiment where the indicating body 4 is present in the closed space 7, one way, of many possible ways, of keeping a more secure counting, the resetting plate 12 will turn with the start of the turning of the combined top 3 and bottom 2, one step on a rotating ratchet, whereby a next number will be shown in the opening 15.

It is also conceivable to arrange the indicating body 4 in a spring (not shown) which will expand when the indicating body 4 is released by an impact force higher than the threshold attachment force, and the indicating body 4 will get caught by the holding means 10. When the top is released from the bottom as in the more basic embodiments, or when the bottom 2 jointly with the top 3 is raised above the holding means 10 according to a more advanced embodiment, the force between the holding means 10 and the indicating body 4 is decreased, and the spring will contract so that the indicating body 4 again will attach to the attachment point 6 in the center of the top 3, on its inside facing the bottom. This could especially be helpful in the more advanced embodiment where a person cannot use their fingers to return the indicating body 4 to the attachment point 6.

The angle direction markings 5 on bottom 2 preferably indicate at least 0-, 45-, and 90-degrees angles. An impact in the vicinity of the 45-degrees angles could indicate that the user has been exposed to rotating forces, too.

An impact indicator of any embodiment may be used on a protective garment. It could be attached in a releasable manner, in a fixed manner or integrated in the protective garment. Preferably, the protective garment is a helmet. The helmet could be for any type of use, but preferably for any kind of sporting or competing use. Preferably, the impact indicator 1 is attached at the top, centrally, of a helmet. The impact indicator 1 may have an arrow or any other marking indicating how to attach it in the right angle, for example an arrow pointing straight forward, towards the opening for a user's face. It is also conceivable to attach the impact indicator from an inner opening, head opening, of the helmet, in a recess, having the top facing the inner opening so that the impact indicator may be visible when the helmet is taken off.

In any embodiment, it is possible to provide the side of the bottom 2 facing the top 3 with for example a QR code that can be read by a mobile phone and launch a downloaded app for the impact indicator. There, it could for example be possible to add information of an impact, date and time and keep track of the number of impacts.

What is claimed is:

1. An impact indicator comprising a bottom, a transparent or translucent top and an indicating body, a space is present between the bottom and the top for the indicating body to move in, the space is delimited by an outer rim, along an outer edge of the impact indicator, being a portion of the bottom, the top and/or a separate part, along the outer edge a holding means for the indicating body is provided, an attachment point is arranged to releasably hold the indicating body by means of a magnetic attachment force, wherein the indicating body and the attachment point are configured to allow the indicating body to be released when the impact indicator is exposed to a force that is greater than the magnetic attachment force, and the holding means along the outer edge is configured to releasably hold the released indicating body by means of a magnetic holding force, wherein the top has a centrally positioned attachment point for the indicating body, further the impact indicator comprises a resetting plate arranged in connection with the bottom, wherein the holding means is attached at the resetting plate, thus making the impact indicator resettable after an impact without having to open the space between the top and the bottom.

2. The impact indicator of claim 1, wherein the indicating body is moveable from the attachment point through the space to the holding means without any friction in exact the direction caused by an impact, without any direction controlling means.

3. The impact indicator of claim 1, wherein the impact indicator has a circular outer edge.

4. The impact indicator of claim 1, wherein the attachment force between the attachment point and the indicating body has a threshold attachment force where the indicating body will release from the attachment point when an impact occur, which is 10-100 G depending on what type of helmet it is and if it is for a child, youth or an adult.

5. The impact indicator of claim 4, wherein the holding force between the holding means and the indicating body after an impact is the same or larger than the threshold attachment force.

6. The impact indicator of claim 1, wherein the top will break at an impact force larger than 200 G-300 G.

7. The impact indicator of claim 1, wherein the top is provided with a thread, bayonet or snap coupling at the edge.

8. The impact indicator of claim 1, wherein the bottom having angle direction markings.

9. A helmet provided with an impact indicator of claim 1.

10. The helmet of claim 9, wherein the impact indicator is provided at a central position at a top of the helmet.

11. The helmet of claim 9, wherein the impact indicator is attached to an outside of the helmet.

12. The helmet of claim 9, wherein the impact indicator is imbedded in a shell of the helmet.
